(19) United States
(12) Patent Application Publication
(10) Pub. No.: US 2019/0297857 A1
(43) Pub. Date: Oct. 3, 2019

(54) A FLOATING ARRANGEMENT FOR BREEDING FISH AND SHELLFISH

(71) Applicant: IDS Invest AS, Stavanger (NO)

(72) Inventor: Jan Vatsvåg, Stavanger (NO)

(73) Assignee: IDS Invest AS, Stavanger (NO)

(21) Appl. No.: 16/468,965

(22) PCT Filed: Dec. 12, 2017
(86) PCT No.: PCT/NO2017/050318

§ 371 Date: Jun. 12, 2019

(30) Foreign Application Priority Data
Dec. 15, 2016 (NO) 20161999

(51) Int. Cl. A01K 61/60; A01K 61/13; A01K 61/80; A01K 61/95

(52) U.S. Cl. CPC A01K 61/60; A01K 61/95; A01K 61/80; A01K 61/13

(57) ABSTRACT

A floating arrangement is for breeding fish and shellfish. The arrangement has an elongated cylinder element, and a framework attached to the cylinder element and configured to define a cage for the fish and shellfish around the cylinder element. The cylinder element is configured with a buoyancy that constitutes a main portion of the buoyancy of the floating arrangement.

### INTRODUCTION

The present invention relates to a floating arrangement for breeding fish and shellfish. The arrangement comprises an elongated cylinder element, and a framework attached to the cylinder element and configured to define a cage for the fish and shellfish around the cylinder element. The present invention furthermore relates to use of a floating arrangement.

### PRIOR ART

Prior art floating arrangement for breeding fish and shellfish are generally anchored in protected locations, such as in a strait, fjords or other area of water protected by a landmass. However, in order to reduce the environmental effect of the breeding, it is desirable to arrange the breeding offshore, or at least in water less protected and in less proximity to the public and in areas with more steady current as opposed to areas with only tidal current as in protected areas.

A further advantage of arranging the breeding offshore is that the fish and shellfish will be less exposed to infections. For example, when breeding salmon, infections of parasites, such as sea lice, in particularly Lepeophtheirus salmonis, is a problem and reduces the yield. Also the virus Pancreas Disease—PD is a serious threat for today's fish farmers at present locations and represents large economic losses due to fish death and treatment cost.

Arranging the breeding offshore however requires the design of the arrangement to be dimensioned to withstand waves, winds and current present at such offshore locations. The advantages of the offshore location of the arrangement does however not generally compensate for the higher costs involved in such strengthened arrangements. Furthermore, the rough weather conditions makes conventional fish breeding arrangement unsuitable. Prior art arrangements designed for the offshore harsh environment do not accommodate for the operational aspects of the fish and shellfish and are therefore found to be difficult and accordingly problematic in terms of occupational safety and health conditions.

NO336552 discloses a semisubmersible cylindrical net cage structure for breeding fish and shellfish.

### SUMMARY OF THE INVENTION

The invention has for its object to remedy or to reduce at least one of the drawbacks of the prior art, or at least provide a useful alternative to prior art. In particular, a first object of the invention is to provide a cost effective floating arrangement for breeding fish and shellfish in offshore conditions. A second object of the invention is to provide a floating arrangement for breeding fish and shellfish in offshore conditions while maintaining the occupational safety and health conditions during operation of the arrangement. A third object is to provide floating arrangement for breeding fish and shellfish in which infections of parasites is reduced. A fourth object is improved welfare of fish. A fifth object is to provide an offshore floating process facility with large indoor spaces which can serve as a research and development facility with good occupational safety for testing of new equipment and solutions related to fish breeding, treatment and welfare. A sixth object is to improve sorting and reduce the risk of fish and shellfish escaping the arrangement.

The objects of the invention are achieved by means of a floating arrangement for breeding fish and shellfish. The arrangement comprises an elongated cylinder element, and a framework attached to the cylinder element and configured to define a cage for the fish and shellfish around the cylinder element. The arrangement is characterized in that the cylinder element is configured with a buoyancy that constitutes a main portion of the buoyancy of the floating arrangement.

The cylinder element is extending partly into the sea and partly above the surface of the sea. By means of configuring the arrangement so that the main portion of the buoyancy of the floating arrangement is provided by the cylinder element and the framework defining the cage for the fish and shellfish around the cylinder, a rigid construction is provided that is suitable for being located offshore or in less protected waters. The cylinder element is elongated and may have various cross sections. The cylinder element may for example have the shape of a circular cylinder, an elliptic cylinder, or any other cross section, such as various types of polyhedrons.

The floating arrangement is having robust motion characteristics and stability to withstand hostile environment, very insensitive to change in variable weights and re-location of weights and provide a good stable working platform in heavy seas.

The feature that “the cylinder element is configured with a buoyancy that constitutes a main portion of the buoyancy of the floating arrangement” shall be interpreted as “the cylinder element is configured with a buoyancy that constitutes more than 50% of the buoyancy of the floating arrangement”.

According to an embodiment of the invention, the cylinder element is configured with a buoyancy that constitutes equal to or more than 80% of the buoyancy of the floating arrangement. Accordingly, all or essentially all of the buoyancy is provided by the cylinder element.

According to an embodiment of the invention, the cylinder element is arranged in a centre of the cage formed by the framework, and wherein the cylinder element is configured with a weight that constitutes a main portion of the weight of the floating arrangement.

The feature that “the cylinder element is configured with a weight that constitutes a main portion of the weight of the floating arrangement” shall be interpreted as “the cylinder element is configured with a weight that constitutes more than 50% of the weight of the floating arrangement”.

According to an embodiment of the invention, the cylinder element is configured with a weight that constitutes equal to or more than 60% of the weight of the floating arrangement.

By providing the main portion of the weight at the cylinder element, the mass centre is arranged at the cylinder element, such as together with a large space on bottom of the cylinder to support the weight, which facilitates transportation of the arrangement from a manufacturing location to its offshore location either through a self-floating tow or transported on a submersible heavy lift carrier. Furthermore, a deformation or other structural damages of the framework has little influence on the stability of the arrangement. The structure is redundant and can sustain severe damage without losing its integrity.

According to an embodiment of the invention, the arrangement comprises an anchoring arrangement comprising anchoring lines adapted to extend towards the seabed from the fairleads at the cross sections between the bottom slanted and vertical trusses in each of the eight corners. Preferably, the anchoring arrangement comprises eight to twelve anchoring wires/chains extending to the seabed where the number of lines depend upon the hostility of the environment.

According to an embodiment of the invention, the cylinder element is arranged in the centre of the extension of the cage formed by the framework.

According to an embodiment of the invention, the centre of gravity of the arrangement is arranged located at a portion of the cylinder that is adapted to be located under the surface of the sea in operation.

According to an embodiment of the invention, an inside of the cylinder element comprises means for treatment of the fish and shellfish. By means of arranging means for treatment of the fish and shellfish in the cylinder the operation of the arrangement is facilitated and can be conducted independently and without particular influence of weather conditions at the offshore location of the arrangement.

According to an embodiment of the invention, the means for treatment of the fish and shellfish comprises at least one of an arrangement for providing feed into the cage, an arrangement for storing feed, an arrangement for treatment of infections of the fish and shellfish, an arrangement for treatment of dead fish and shellfish, an arrangement for distributing the fish and shellfish, an arrangement for sorting the fish and shellfish, an arrangement for harvesting and an arrangement for research and testing out new equipment for improving the fish welfare and/or growth and an arrangement for slaughtering the fish and shellfish.

The infections on the fish and shellfish are for example sea lices, amoebas, etc. All arrangements, means and facilities are preferably more or less automated. Preferably, the cylinder element is provided with large indoor spaces which can serve as a research and development facility with good occupational safety for testing of new equipment and solutions related to fish breeding, treatment and welfare.

According to an embodiment of the invention, the floating arrangement further comprises an arrangement for distributing fish and shellfish to and from a rim of the arrangement. The arrangement for distributing fish and shellfish comprises for example pipes extending from the cylinder element to the rim of arrangement.

According to an embodiment of the invention, the cylinder element further comprises a control room comprising a control unit for controlling the means for treatment and surveillance of the fish and shellfish both indoor and in the cage by underwater cameras and other monitoring devices. The control room is preferably also be used for control of other marine operations in connection to the arrangement.

According to an embodiment of the invention, the cylinder element further comprises a living area for personal.

By arranging the cylinder element of an extent that allows the main functions of the arrangement to be provided inside the cylinder element, the operation of the arrangement at offshore location is facilitated.

According to an embodiment of the invention, the framework is configured to form a bottom surface of the cage and the cylinder element is arranged extending at least to the bottom surface.

According to an embodiment of the invention, the framework of the bottom surface is arranged slanted in respect to the extension of the cylinder element and extending towards the cylinder element.

According to an embodiment of the invention, the cylinder element comprises an inlet at an intersection between the bottom surface and the cylinder element, which inlet is adapted to receive and conduct dead fish and shellfish away from the bottom surface into an inner of the cylinder element.

By means of guiding dead fish and shellfish towards the cylinder element, the dead fish and shellfish can quickly be removed from the cage and thereby reducing the risk of infections spreading to the remaining fish and shellfish in the cage.

According to an embodiment of the invention, the framework is configured to divide the cage in two or more separate compartments for the fish and shellfish. By means of dividing the cage in two or more separate compartments around the cylinder element, different compartments can involve different stages in the breeding of the fish and shellfish. Preferably, the cage is divided in eight separate compartments around the cylinder element. The segmentation of the cage in compartments increases the harvestable fish due to improved sorting and reduced risk for fish escaping.

According to an embodiment of the invention, the compartment are symmetrical arranged around the cylinder element. Thereby, the arrangement is configured with symmetry that result in that the arrangement is subjected to the same loads regardless of direction wind, waves and current are directed.

According to an embodiment of the invention, the arrangement comprises a movable separation that divides each compartment in an upper partition and a lower partition.

By means of the partitions and the movable separation, in case there is indication of risk of exposure to infections of sea lice, the fish and shellfish can be arranged in the lower partition and be forced down further from the surface of the sea by means of the movement of the movable separation.

The sea lice are generally present close to the surface of the sea. Accordingly, by forcing the fish and shellfish down away from the surface of the sea, the risk of infection is reduced. Also, in case of indication of risk of exposure to jellyfish and similar, the fish and shellfish can be forced down away from the surface by means of the movable separation.

According to an embodiment of the invention, the movable separation is extendable and retractable from the cylinder element towards and away from a rim of the framework. By means of arranging the movable separation is extendable and retractable, the division of the cage in the upper and lower partition can be controllable established and disestablished. The moveable separation can be lowered to the bottom of the cage and the net engaged and thereafter used to push the fish upwards for crowding and entering the fish into the fish distribution system.

According to an embodiment of the invention, the movable separation comprises an extended state in which said partitions are established and retracted state in which the said partitions are disestablished, wherein the movable separation has a form in the extended state that essentially conform to the form of the compartment. Preferably, the outer rim of each compartment is configured comprising a straight edge.

According to an embodiment of the invention, the floating arrangement comprises means for distributing the fish and shellfish between the upper partition and the lower partition of the compartments. The means for distributing the fish and shellfish between the partitions comprises inlet/outlet and piping with special designed selection valves between partitions. Preferably, the inlet/outlets are arranged on different locations on the cylinder element along the extension of the cylinder element.

According to an embodiment of the invention, the cylinder element comprises one or more ballast tanks and means for controllable regulating a ratio between air and water in the tanks, wherein the ballast tanks are arranged in a part of the cylinder element configured to be submerged under the surface of the sea.

According to an embodiment of the invention, the means for distributing the fish and shellfish comprises inlet/outlet at all of the compartments and partitions of the cage.

According to an embodiment of the invention, cylinder element comprises an internal fish distributing system that can bring the fish into various stations such as for sorting, treatment, harvesting or to any of the available compartments. The system is even flexible enough to transfer the fish back into the same cage without mixing with other fish and shellfish from other compartments.

According to an embodiment of the invention, the framework comprises wall sections of pipes filled with water. By means of filling the pipes of the wall sections with water, a deformation or leakage of the pipes will not change the stability or the strength of the arrangement.

According to an embodiment of the invention, the framework comprises wall sections and netting extending between the wall sections. The combination of the wall sections and the netting defines the cage for the fish and shellfish.

According to an embodiment of the invention, the framework comprises wall sections extending slanted in respect to the extension of the cylinder element from a rim of the formed cage to the cylinder element. The slanted wall sections of the framework has the function of increasing the damping of the vertical motions and reducing vortex shedding and thereby forces and motions subjected to the arrangement.

The object of the invention is furthermore obtained by use of a floating arrangement according to any of claim 1-20.

### BRIEF DESCRIPTION OF THE DRAWINGS

In the following is described examples of a preferred embodiment illustrated in the accompanying drawings, wherein:

FIG. 1 discloses a floating arrangement for breeding fish and shellfish according to an embodiment of the invention; and

FIG. 2-6 discloses the floating arrangement in FIG. 1 in further details.

### DETAILED DESCRIPTION

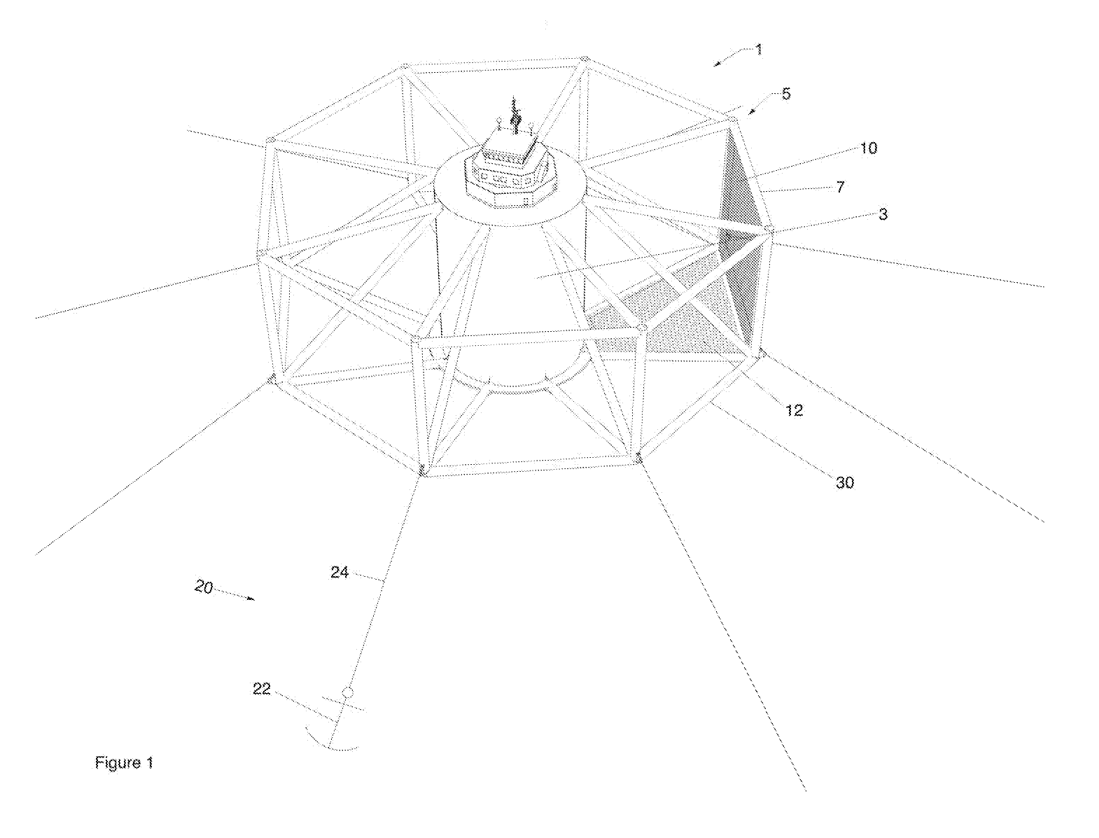

In FIG. 1 a floating arrangement 1 for breeding fish and shellfish according to an embodiment of the invention is disclosed. The arrangement 1 comprises an elongated cylinder element 3 and a framework 5 attached to the cylinder element 3. The framework 5 comprises a plurality of wall sections 7 that define a cage 10 for the fish and shellfish around the cylinder element 3. The framework 5 further comprises netting 12 extending between the wall sections 7.

The arrangement 1 is floating at the surface of the sea so that a lower portion of the cylinder element 3 is submerged in the sea and an upper portion of the cylinder element 3 is arranged above the surface of the sea.

The arrangement 1 comprises an anchoring arrangement 20 comprising anchors 22 and anchoring lines 24 adapted to extend towards the seabed. In FIG. 1, the anchoring arrangement 20 is schematic showing eight anchoring wires 24 extending to the anchors 22 at the seabed. Preferably, the anchoring arrangement 20 comprises eight to twelve anchoring lines 24 extending to the anchors 22 at the seabed.

The cylinder element 3 is configured floatable and providing a buoyancy that constitutes a main portion of the buoyancy of the floating arrangement 1. Preferably, the cylinder element 3 provides almost all of the buoyancy of the floating arrangement 1, such as equal or more than 80% of the buoyancy of the floating arrangement 1. The cylinder element 3 is arranged in a centre of the cage 10 and has a weight that constitutes a main portion of the weight of the floating arrangement. Preferably, the cylinder element 3 constitutes most of the weight of the floating arrangement 1, such as equal or more than 60% of the weight of the floating arrangement 1.

The cylinder element 3 furthermore comprises ballast tanks and means for controllable regulating a ratio between air and water in the tanks, wherein the ballast tanks are arranged in a part of the cylinder element 3 configured to be submerged under the surface of the sea. The cylinder element 3 and the anchoring arrangement 20 are arranged in a configuration same or similar to the design of a spar offshore platform.

In the disclosed embodiment, a portion of the wall sections 7 of the framework 5 are arranged extending slanted in respect to the extension of the cylinder element 3 from a rim of the formed cage 10 to the cylinder element 3. The slanted wall sections 7 have the function to increase the vertical damping and thereby reduce the motions and reduce vortex shedding and thereby forces subjected to the arrangement 1.

By means of the above configuration of the arrangement 1, a rigid construction is provided that is adapted to withstand offshore conditions. The arrangement 1 also facilitates the stability when transporting the arrangement 1 on a heavy lift carrier from the manufacturing site to the offshore location of the arrangement 1.

The cylinder element 3 comprises an inside volume for treatment of the fish and shellfish. The means for treatment of the fish and shellfish comprises for example an arrangement for providing feed into the cage, an arrangement for storing feed, an arrangement for treatment of infections of the fish and shellfish, an arrangement for treatment of dead fish and shellfish, an arrangement for distributing the fish and shellfish, an arrangement for sorting the fish and shellfish, and an arrangement for slaughtering the fish and shellfish.

Furthermore, the floating arrangement 1 further comprises an arrangement for distributing fish and shellfish to and from a rim of the arrangement 1. The arrangement for distributing fish and shellfish comprises pipes extending from the cylinder element 3 to the rim of the floating arrangement 1.

The cylinder element 3 further comprises a control room comprising a control unit for controlling the means for treatment of the fish and shellfish and the arrangement for distributing fish and shellfish to and from the rim of the arrangement 1. Also other marine operation in connection to the arrangement 1 can be controlled from the control room.

The arrangement 1 is further configured so that the inside of the cylinder element 3 comprises a living area for personal, which facilitates the operation of the arrangement 1.

The framework 5 is configured to form a bottom surface 30 of the cage 10. The bottom surface 30 is arranged slanted in respect to the extension of the cylinder element 3. The cylinder element 3 is extending towards the bottom surface 30 and comprises an inlet at an intersection between the bottom surface and the cylinder element 3. The inlet is adapted to receive and conduct dead fish and shellfish away from the bottom surface 30 into an inner of the cylinder element 3.

The framework 5 is configured to divide the cage 10 in a plurality of separate compartments for the fish and shellfish. In the disclosed embodiment, the framework 5 divides the cage 10 in eight separate compartments. The cylinder element 3 comprises the arrangement for distributing the fish and shellfish as mentioned previously and is configured to distribute the fish and shellfish between the different compartments. The cylinder element 3 comprise an inlet/outlet for the fish and shellfish at each of the compartments.

The arrangement 1 further comprises a movable separation that divides each compartment in an upper partition and a lower partition. The movable separation is displaceable along the extension of the cylinder element 3. Preferably, the movable separation is extendable and retractable from the cylinder element towards and away from a rim framework. Thereby, the division of the compartment can be established and disestablished. Preferably, the arrangement for distributing the fish and shellfish comprises an inlet/outlet at the cylinder element 3 for the respective upper partition and the lower partition of the compartments.

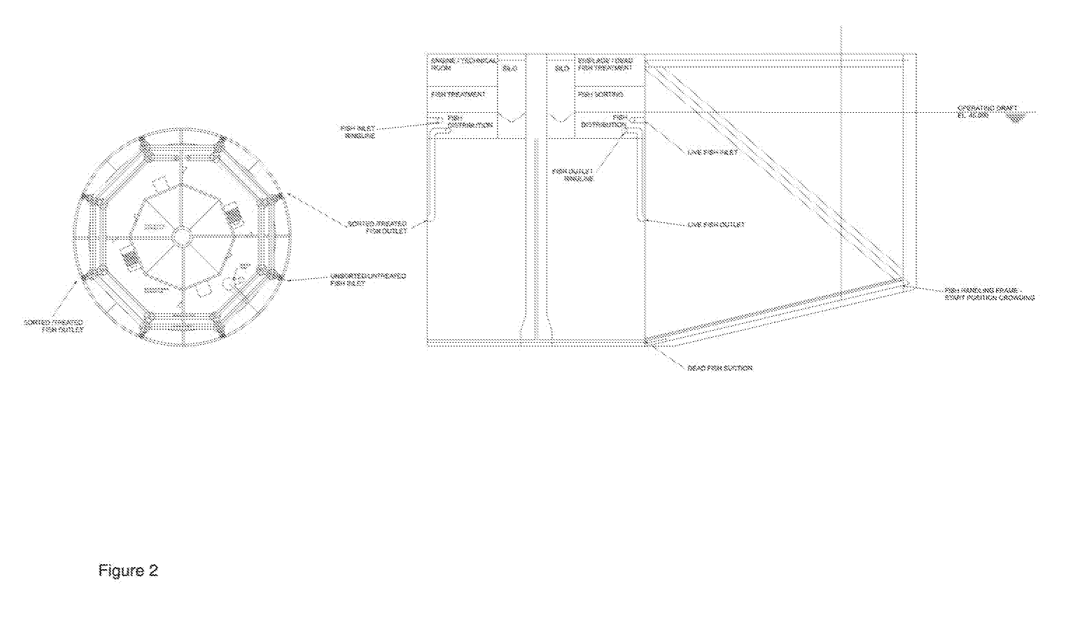

In FIG. 2-6, the floating arrangement in FIG. 1 is disclosed in further details. In the following the term “fish” is used in general for fish and shellfish.

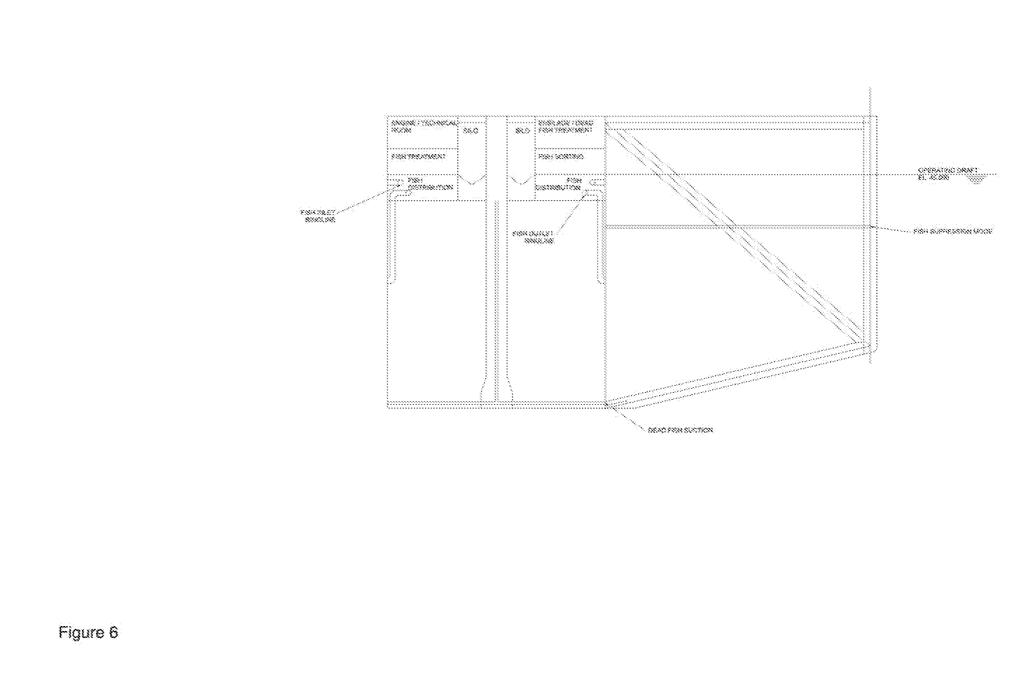

Each compartment comprising a movable separation, further denoted fish handling frame, that is stored in upper position, as shown in FIG. 6. The frame is lowered down to the bottom of the cage 10, see FIG. 2. A net is rolled up at one of the sides and pulled across to ensure that the fish cannot escape underneath the frame when it is being raised up in the water.

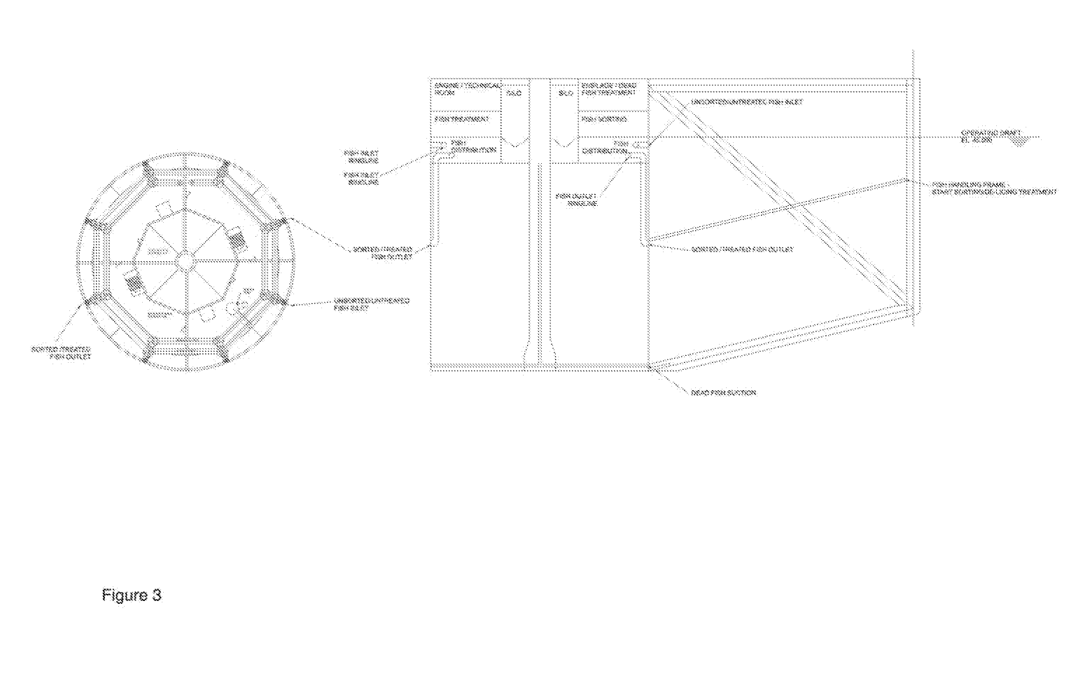

The frame is pulled up to the position in FIG. 3, just above the outlet from the fish transportation pipe, named as «dive fish outlet». The fish is then crowded together and when the «fish inlet» valve is opened, the fish will flow into a fish distribution system, where the fish may be sorted, treated for diseases etc., distributed to other compartments of the cage 10 or uploaded to the transportation vessel for slaughtering.

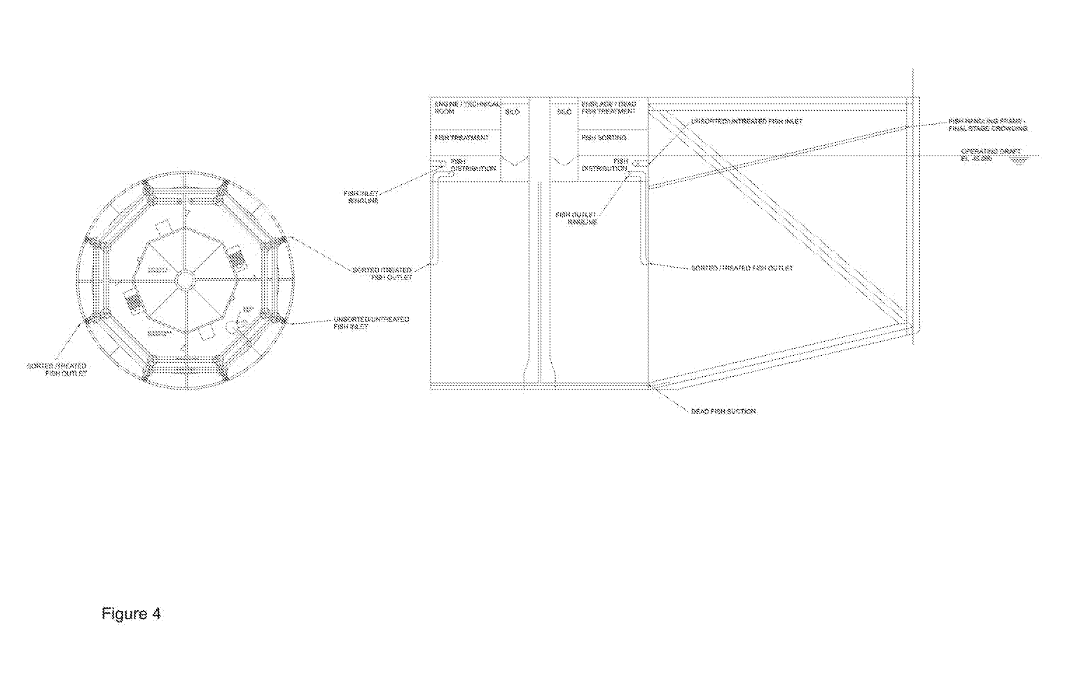

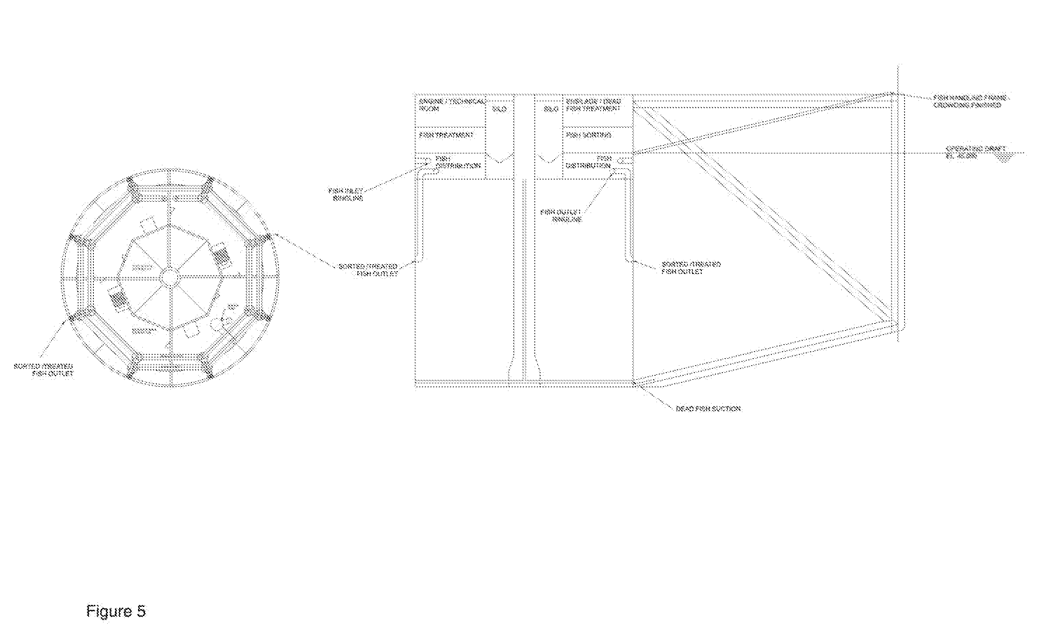

The distribution system can be used to send either all or some of the fish back into the cage at the lower partition of the compartment underneath the fish handling frame. See in FIG. 3 in which the handling frame is just above the outlet of the «fish outlet» opening. The treated or sorted fish can then be returned to the same compartment or partition without being mixed with the fish that is due to be handled. Alternatively the treated or sorted fish can be returned to other compartments of the cage 10. By this arrangement, the distribution system is highly flexible. FIGS. 4 and 5 show the fish being further crowded as the fish enters the fish inlet to the distribution system. The crowding system allows 100% emptying the cage, not leaving any unsorted or untreated fish in the cage.

The handling frame can also be used to protect the fish from lice. The net is the pulled across the handling frame while it is in upper position, see FIG. 6. The lices are normally in a belt that is not deeper than 10 meters below the water surface. This means that the handling frame can be used to push downwards so the fish are kept below the lice belt for a period of time and thereby avoid being infected.

The handling frame comprising the fish net, fairleads at each of the columns, a fish net fitted onto a bar with a mechanism that it can be pulled in and out to the other side. There are also trolleys to adjust the vertical position in the water. Since it is only one side with a fixed bar, the trolleys can be adjusted to be inclined in both directions, i.e. the lifting frame can be tilted the other direction than shown in the FIGS. 2-6, to crowd the fish outward if the distribution system is not in use. The fish transportation vessel can then use its own equipment to take the fish out of the cage.

It should be noted that the above-mentioned embodiments illustrate rather than limit the invention, and that those skilled in the art will be able to design many alternative embodiments without departing from the scope of the appended claims.

For example, it shall be understood that the movable separation of the compartments may be applicable for an arrangement not restricted to comprising the cylinder element. It shall also be understood that the movable separation may be applicable to a single compartment of an arrangement for breeding fish and shellfish.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. A floating arrangement for breeding fish and shellfish, the arrangement comprising:
an elongated cylinder element, and
a framework attached to the cylinder element and configured to define a cage for the fish and shellfish around the cylinder element,
wherein the cylinder element is arranged in a center of the cage formed by the framework, wherein the cylinder element is configured with a buoyancy that constitutes a main portion of the buoyancy of the floating arrangement, and wherein the cylinder element is configured with a weight that constitutes a main portion of the weight of the floating arrangement.

2. The floating arrangement according to claim 1, wherein the cylinder element is configured with a buoyancy that constitutes equal to or more than 80% of the buoyancy of the floating arrangement.

3. (canceled)

4. The floating arrangement according to claim 1, wherein the cylinder element is configured with a weight that constitutes equal to or more than 60% of the weight of the floating arrangement.

5. The floating arrangement according to claim 1, wherein an inside of the cylinder element comprises means for treatment of the fish and shellfish.

6. The floating arrangement according to claim 4, wherein the means for treatment of the fish and shellfish comprises at least one of an arrangement for providing feed into the cage, an arrangement for storing feed, an arrangement for treatment of infections of the fish and shellfish, an arrangement for treatment of dead fish and shellfish, an arrangement for distributing the fish and shellfish, an arrangement for sorting the fish and shellfish, an arrangement for research and development and an arrangement for slaughtering the fish and shellfish.

7. The floating arrangement according to claim 1, wherein the floating arrangement further comprises an arrangement for distributing fish and shellfish to and from a rim of the arrangement.

8. The floating arrangement according to claim 1, wherein the cylinder element further comprises a control room comprising a control unit for controlling the means for treatment of the fish and shellfish.

9. The floating arrangement according to claim 1, wherein the cylinder element further comprises a living area for personal use.

10. The floating arrangement according to claim 1, wherein the framework is configured to form a bottom surface of the cage and the cylinder element is arranged extending at least to the bottom surface.

11. The floating arrangement according to claim 9, wherein the framework of the bottom surface is arranged slanted in respect to the extension of the cylinder element and extending towards the cylinder element.

12. The floating arrangement according to claim 9, wherein the cylinder element comprises an inlet at an intersection between the bottom surface and the cylinder element, which inlet is adapted to receive and conduct dead fish and shellfish away from the bottom surface into an inner of the cylinder element.

13. The floating arrangement according to claim 1, wherein the framework is configured to divide the cage in two or more separate compartments for the fish and shellfish.

14. The floating arrangement according to claim 12, wherein the arrangement comprises a movable separation that divides each compartment in an upper partition and a lower partition.

15. The floating arrangement according to claim 13, wherein the movable separation is extendable and retractable from the cylinder element towards and away from a rim of the framework.

16. The floating arrangement according to claim 12, wherein the floating arrangement comprises means for distributing the fish and shellfish between the upper partition and the lower partition of the compartments.

17. The floating arrangement according to claim 1, wherein the cylinder element comprises one or more ballast tanks and means for controllable regulating a ratio between air and water in the tank, wherein the ballast tanks are arranged in a part of the cylinder element configured to be submerged under the surface of the sea.

18. The floating arrangement according to claim 1, wherein the framework comprises wall sections of pipes filled with water.

19. The floating arrangement according to claim 1, wherein the framework comprises wall sections and netting extending between the wall sections.

20. The floating arrangement according to claim 1, wherein the framework comprises wall sections extending slanted in respect to the extension of the cylinder element from a rim of the formed cage to the cylinder element.

21. Use of a floating arrangement according to claim 1.
